(19) United States
(12) Patent Application Publication
(10) Pub. No.: US 2013/0160130 A1
(43) Pub. Date: Jun. 20, 2013

(54) APPLICATION SECURITY TESTING

(71) Applicants: Kirill Mendelev, Atlanta, GA (US); Iftach Ragoler, Alpharetta, GA (US); Brian V. Chess, Palo Alto, CA (US); Spencer James Firestone, Foster City, CA (US); Yaron Kfir, San Francisco, CA (US)

(72) Inventors: Kirill Mendelev, Atlanta, GA (US); Iftach Ragoler, Alpharetta, GA (US); Brian V. Chess, Palo Alto, CA (US); Spencer James Firestone, Foster City, CA (US); Yaron Kfir, San Francisco, CA (US)

(21) Appl. No.: 13/331,777

(22) Filed: Dec. 20, 2011

(51) Int. Cl. G06F 21/00

(52) U.S. Cl. 726/25

(57) ABSTRACT

In one implementation, an attack surface identification system defines an interface description of an application during execution of the application. The interface description is then provided to a scanner.

### BACKGROUND

Application or software security testing is used to assess an application such as a web application for vulnerabilities or attack vectors. One approach to software security testing is referred to as black-box security testing. Black-box security testing for web applications involves a security testing application (or scanner) which simulates an attacker. The scanner explores the application (here, the web application) which can also be referred to as an application under test by making Hypertext Transfer Protocol (HTTP) requests and evaluating HTTP responses from the application (or from an application server hosting the application on behalf of the application) to identify the attack surface of the application (e.g., Uniform Resource Identifiers (URIs) at which the application accepts input).

The scanner then executes attacks based on the attack surface such as HTTP requests directed to URIs at which the application accepts input that are particularly crafted to (e.g., have data payloads to) test for attack vectors such as memory buffer overflows, Structured Query Language (SQL) injection, privilege elevation, and arbitrary code execution, for example. Additionally, the scanner can diagnose the presence or absence of vulnerabilities by evaluating HTTP responses from the application. Under the black-box security testing approach, the scanner does not have insight about the internal workings of the application.

### BRIEF DESCRIPTION OF THE DRAWINGS

FIG. 1 is a flowchart of an attack surface identification process, according to an implementation.

FIG. 2 is an illustration of an environment including a scanner and an attack surface identification system, according to an implementation.

FIG. 3 is a schematic block diagram of the computing device of FIG. 2 hosting an attack surface identification system, according to an implementation.

FIG. 4 is a schematic block diagram of an attack surface identification system, according to an implementation.

FIG. 5 is a flowchart of an attack surface identification process, according to another implementation.

FIG. 6 is an illustration of an attack surface identification system in communication with an application server and applications hosted at the application server, according to an implementation.

FIG. 7 is a flowchart of an attack surface identification process, according to another implementation.

### DETAILED DESCRIPTION

In contrast to black-box security testing, another approach to software security testing is referred to as gray-box security testing. Under the gray-box security testing approach, the scanner is provided with information about the internal workings of the application. For example, information about the attack surface and the internal processing of the application can be extracted from the source code of the application and included in the logic of the scanner before a security test begins. Such a scanner can perform security testing of an application using the information about the internal workings of the application.

Although gray-box security testing can enhance a security assessment of an application with comparison to black-box security testing, gathering the information about the attack surface and internal processing of the application can be time consuming and error-prone. For example, such information can be assembled manually by developers of the application, allowing for human error to affect the information. Additionally, if such information is extracted from the application before a security test begins (e.g., from source code of the application using static code analysis methodologies) the application can be altered or modified before the test or, for example, by an application server at which the application is hosted at runtime of the application. Moreover, such information must be gathered and implemented in the logic of the scanner for each application that will be tested (i.e., each application under test). Accordingly, subsequent security testing of the application (at runtime of the application) can provide inaccurate results that identify security vulnerabilities that do not exist at the application (false positives) and/or that fail to identify security vulnerabilities that do exist at the application (false negatives).

Implementations discussed herein provide information related to the attack surface of an application to a scanner during runtime. For example, an attack surface identification system hosted at a computing device at which the application is hosted can identify an attack surface (or a portion thereof) of the application dynamically (or during runtime or execution of the application), and provide a description of the attack surface to a scanner. The scanner can then use the description of the attack surface to assess security vulnerabilities of the application.

The attack surface identified by the attack surface identification system can be more comprehensive than an attack surface identified by a black-box scanner (i.e., a scanner employing a black-box testing approach) because, for example, the attack surface identification system can interact with the application in the application's hosting environment (e.g., a computing device hosting the application, a application server hosting the application, or a framework of the application) to identify the attack surface of the application. Moreover, because the information related to the attack surface is generated dynamically (during runtime of the application), information about the attack surface of the application need not be provided to the scanner prior to security testing of the application.

Some systems, methods, and apparatus for security testing discussed herein can be particularly beneficial to identify components of applications with a Representational State Transfer (REST) architecture. Applications or interfaces of applications that conform to principles of REST are often referred to as RESTful. Because RESTful applications often do not directly expose their interfaces and informal definition of such interfaces is encouraged to quicken the application development process, the security testing methodologies discussed herein can be particularly beneficial to applications with (or that expose) RESTful interfaces.

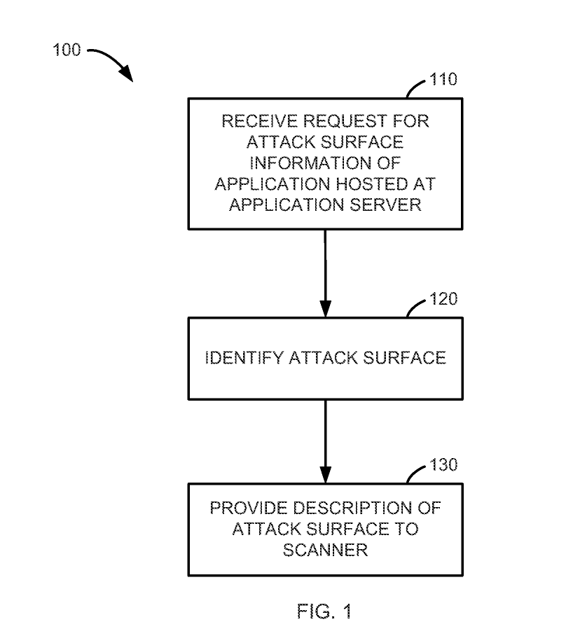

As an example of an attack surface identification system, FIG. 1 is a flowchart of an attack surface identification process, according to an implementation. As illustrated in FIG. 1, an attack surface identification system receives a request at block 110 for attack surface information of an application hosted at an application server. The request at block 110 can be received from a scanner performing or preparing to perform security vulnerability testing or analysis of the application hosted at the application server. In other implementations, the attack surface identification system implementing process 100 performs blocks 120 and 130 independent of requests for attack surface information.

The attack surface identification system implementing process 100 then identifies the attack surface at block 120. The attack surface is identified dynamically while the application is hosted at the application server. Said differently, the attack surface is identified at runtime of the application. For example, the attack surface can be identified based on information received or extracted from the application in response to execution of monitor code at a processor. Identification of attack surfaces is discussed in more detail below in relation, for example, to FIGS. 4, 5, and 7.

After identifying the attack surface of the application, the attack surface identification system implementing process 100 provides interface descriptions of the application (or a description of the attack surface of the application) to the scanner. The interface descriptions can include URIs at which resources of the application are accessible, parameter names and/or ranges, and/or other information that describes the attack surface of the application. Additionally, the interface descriptions can include types of operations or requests handled, serviced, or processed by the application. As a specific example, the interface descriptions can identify HTTP methods (e.g., GET, PUT, and POST) serviced by the application. Thus, for example, the interface descriptions can specify URIs, HTTP methods serviced at those URIs, and parameter names and/or ranges accepted as input by those HTTP methods. The scanner can then use the description of the attack surface to formulate attacks to expose or identify security vulnerabilities of the application.

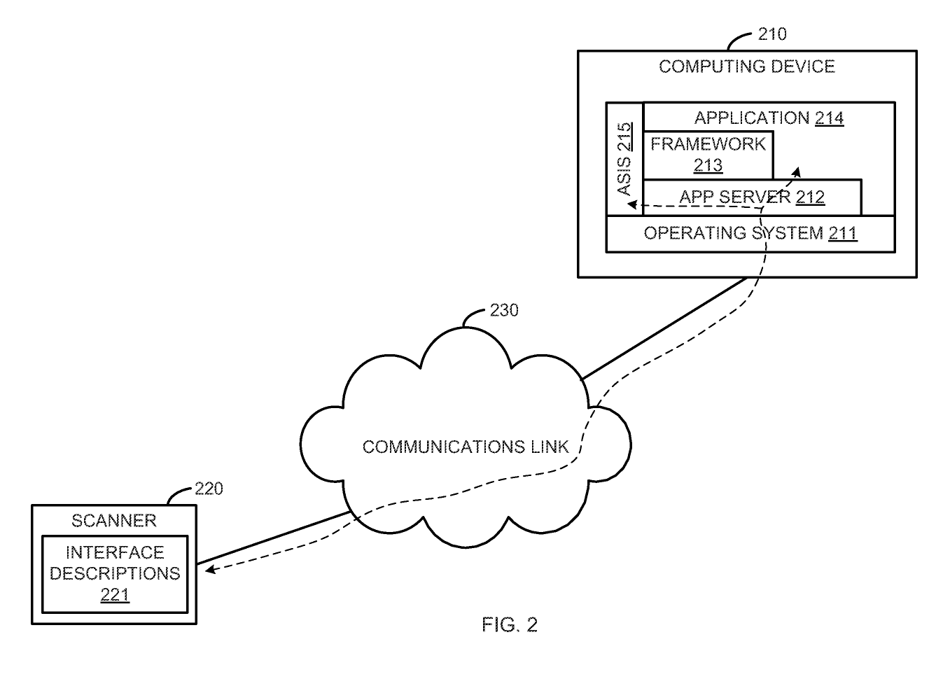

FIG. 2 is an illustration of an environment including a scanner and an attack surface identification system, according to an implementation. Although various modules (i.e., combinations of hardware and software) are illustrated and discussed in relation to FIGS. 2-6 and other example implementations, other combinations or sub-combinations of modules can be included within other implementations. Said differently, although the modules illustrated in FIGS. 2-6 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

The environment illustrated in FIG. 2 includes computing device 210, scanner 220, and communications link 230. Computing device 210 hosts operating system 211, application server (labeled APP SERVER) 212, framework 213, application 214, and attack surface identification system (labeled ASIS) 215. Operating system 211, application server 212, framework 213, application 24, and attack surface identification system 215 are each modules that are stored at a memory and executed at a processor (or are hosted at computing device 210).

Communications link 230 includes devices, services, or combinations thereof that define communications paths between application 214, attack surface identification system 215, scanner 220, and/or other devices or services. For example, communications link 230 can include one or more of a cable (e.g., twisted-pair cable, coaxial cable, or fiber optic cable), a wireless link (e.g., radio-frequency link, optical link, or sonic link), or any other connectors or systems that transmit or support transmission of signals. Communications link 230 can include communications networks such as an intranet, the Internet, other telecommunications networks, or a combination thereof. Additionally, communications link 230 can include proxies, routers, switches, gateways, bridges, load balancers, and similar communications devices. Furthermore, the connections and communications paths (e.g., between scanner 220, application 214, and attack surface identification system 215) illustrated in FIG. 2 are logical and do not necessarily reflect physical connections.

Scanner 220 emulates a client of application 214 to conduct security tests of application 214. For example, scanner 220 can submit requests (e.g., using a protocol of a client of application 214) to and examine responses from application 214 to test for, identify, expose, and/or exploit security vulnerabilities of application 214. As specific example, scanner 220 can perform black-box security testing, gray-box security testing, security testing using interface descriptors discussed herein, or some combination thereof on application 214.

Computing device 210, operating system 211, application server 212, and framework 213 can be referred to as the hosting environment of application 214. That is, computing device 210, operating system 211, application server 212, and framework 213 provide resources and/or runtime support to application 214 during execution or runtime of application 214. Said differently, application 214 interacts with computing device 210, operating system 211, application server 212, and framework 213 during runtime to provide, for example, a service to clients (not shown) of application 214. In some implementations, the hosting environment of application 214 includes additional or different components not shown in FIG. 2 such as a virtual machine or runtime environment (e.g., Java Virtual Machine™ (JVM) or Microsoft .NET Common Language Runtime™ (CLR). For example, application server 212 and application 214 can be hosted at a JVM.

More specifically, for example, application server 213 can provide a container (or environment) within which application 214 can execute. Examples of application servers include Tomcat™, JBoss™, IBM WebSphere™, and Oracle WebLogic™. As another example, framework 213 can provide various services such as marshalling of data (e.g., URIs, parameters of URIs, and parameters of HTTP methods). In some implementations, elements of the hosting environment of application 214 can cooperate to provide runtime support to application 214. For example, application server 212 and framework 213 can cooperatively provide communications protocol support such as parsing and marshalling HTTP requests and assembling HTTP responses on behalf of application 214.

Framework 213 is a module or group of modules with functionalities that are accessible to application 214 via an application programming interface (API). In some implementations, framework 213 maps an interface (e.g., at which requests are received and from which responses are provided by or on behalf of application 214) to modules of an application such that each request (and related parameters or arguments) received at that interface are provided to modules of the application that are configured or adapted to process that particular request. As examples, framework 213 can define mappings between interfaces and modules using relationships among classes or instances of classes, annotations such as metadata related to classes or instances of classes, annotations to source code, object code, or bytecode of application 214, or other descriptions of a relationship between an interface and one or more modules. Such mappings or annotations describing such mappings can be referred to as interface mappings.

For example, framework 213 can be a RESTful framework that marshals RESTful-formatted HTTP requests for a service to modules of application 214. As specific examples, Apache CXF™, Jersey™, RESTEasy™, Restlet™, and Apache Wink™ are frameworks for Java™-based applications that implement the Java API for RESTful Web Services (JAX-RS), and utilize annotations within applications to map a RESTful interface to modules of those applications. These annotations describe which RESTful requests (and related parameters or arguments) are marshaled to which modules. As another example, Microsoft ASP .NET MVC™ is a framework that facilitates mappings between a RESTful interface and specific modules of applications based on Microsoft ASP .NET MVC™ using various data structures such as classes included in the System.Web.Routing namespace.

Such frameworks map a RESTful interface (e.g., an interface at which RESTful requests are received and from which RESTful responses are provided) to modules of an application such that each RESTful request (and related parameters or arguments) received at that interface are provided to modules of the application that are configured or adapted to process that RESTful request. Such mappings or annotations describing such mappings can be referred to as RESTful interface mappings. Such RESTful interface mappings describe how portions of RESTful service requests received at a RESTful interface (e.g., defined by an application or application server) are mapped to modules of an application.

As specific examples, a RESTful interface mapping can describe the parameter names, ranges of parameter values, and parameter data types that are accepted at a RESTful interface and how those parameter names, ranges of parameter values, and parameter data types are handled by an application (e.g., which modules of the application handle or receive input having particular parameter names, ranges of parameter values, and parameter data types). For example, a RESTful interface mapping can specify a URI, the HTTP methods available at that URI, and/or parameter names and/or ranges accepted as input by those HTTP methods.

Application 214 is an application hosted at computing device 210 such as a web application (e.g., an application that is accessible via a communications link such as an application hosted at a computer server that is accessible to a user via a web browser and the Internet). As an example, application 214 is a web application that receives a request from a client for a service (e.g., data storage, data retrieval, or data processing); performs the service using logic (e.g., implemented as code or instructions that can be interpreted at a processor) within application 214 and/or services, resources, or functionalities of computing device 210, operating system 211, application server 212, or framework 213; and provides a response related to the service to the client. The requests and responses can conform to a variety of formats, protocols, or interfaces. In other words, application 214 can be accessible via a variety of formats, protocols, or interfaces implemented at one or more of operating system 211, application server 212, framework 213, and/or application 214. For example, application 214 can be accessible via HTTP, a RESTful interface, Simple Object Access Protocol (SOAP), a Remote Procedure Call (RPC) interface, some other interface, protocol, or format, or a combination thereof.

Attack surface identification system 215 is a module or group of modules that is hosted at computing device 210 and can interact with operating system 211, application server 212, framework 213, and/or application 214 to identify an attack surface of application 214. As used herein, an attack surface is the interfaces to (e.g., URIs of, operations handled by, and parameters accepted by) an application that cause a portion or portions of the application to execute. Thus, an attack surface describes which inputs are accepted by the application. For example, an attack surface can be described by interface descriptions including Uniform Resource Identifiers (URIs) such as Uniform Resource Locators (URLs) that describe locations of those interfaces, HTTP methods available at those interfaces, arguments or parameters accepted as input by the application via those HTTP methods (e.g., named parameters of a query string within a URI for an HTTP GET method), and/or ranges of values or data types accepted by the application.

As an example, attack surface identification system 215 can interact with application 214 by modifying operating system 211, application server 212, framework 213, and/or application 214 to observe or monitor application 214 during runtime (or execution) of application 214. For example, attack surface identification system 215 can install (e.g., modify or can inject) code such as Java™ classes for a Java™-based application into code (e.g., bytecode or other code or instructions) implementing application 214. Such installed code can be referred to as monitor code. Said differently, attack surface identification system 215 can instrument application 214 with monitor code.

Such monitor code can allow attack surface identification system 215 to monitor application 214. For example, such monitor code can be located at portions of application 214 that are related to functionalities or processing that attack surface identification system 215 should monitor. When those portions of application 214 are executed, attack surface identification system 215 intercepts execution of application 214. Attack surface identification system 215 intercepts application 214 (or execution of application 214) by executing (e.g., being executed at a processor) in response to execution of a particular portion of application 214. For example, the monitor code transfers the flow of execution from application 214 to attack surface identification system 215 or provides a signal to attack surface identification system 215 to indicate a portion of application 214 has been executed (or that execution of application 214 has reached that portion of application 214). As a specific example, such monitor code can be located at API calls that perform specific operations such as reading a URI parameter or argument, writing to a filesystem, or providing a response to a client of application 214. When those API calls are executed, attack surface identification system 215 intercepts execution of application 214.

After attack surface identification system 215 has intercepted execution of application 214, attack surface identification system 215 can receive or access data related to the execution of application 214. For example, the monitor code can identify or provide access to a call stack, environment variables, method argument values, class names, class instances, file names, filesystem path, source code file line numbers, an operational state, and/or other information related to the execution of application 214 to attack surface identification system 215. Alternatively, for example, attack surface identification system 215 can access such information via operating system 211, application server 212, framework 213, and/or memory allocated to application 214. Attack surface identification system 215 can then analyze such information to identify the attack surface (or elements thereof) of application 214.

As a specific example, the monitor code can access or communicate with an interface such as an API of operating system 211, application server 212, framework 213, application 214, and/or other component of a hosting environment of application 214 that allows debugging or profiling of application 214. As an example, attack surface identification system 215 can monitor and/or intercept application 214 using an API implemented at a runtime environment of application 214 to allow debugging (e.g., by a debugger) or profiling (e.g., by a profiling utility) of application 214 (e.g., access to memory of application 214, access to operating state information of application 214, interruption or interception application 214 using breakpoints, or identification of resources accessed by or allocated to application 214).

As a specific example, application 214 can be a Java application and attack surface identification system 215 can provide rules or instructions identifying specific portions of application 214 such as specific APIs at which breakpoints should be placed to a debugging interface of a JVM hosting application 214. When those portions of application 214 are executed, the JVM can halt execution of application 214 and cause attack surface identification system 215 (e.g., a particular module of attack surface identification system 215) to execute.

Attack surface identification system 215 in response can, for example, access or determine a call stack, environment variables, class names or identifiers, class instances, method argument values, API names or identifiers, file names, a filesystem path, source code file line numbers, an operational state, and/or other information related to the execution of application 214 via a debugging interface of the JVM before allowing (e.g., via the JVM or debugging interface) application 214 resume execution. Similarly, as another specific example, application 214 can be a Microsoft .NET™ application, and attack surface identification system 215 can hook (or attach to) particular portions of application 214 via an interface of a profiling module the Microsoft™ CLR. In other words, attack surface identification system 215 can intercept execution of application 214 (e.g., halt execution of application 214 and begin executing while application 214 is halted) and then analyze application 114.

Moreover, attack surface identification system 215 communicates with scanner 220 to enhance security testing of application 214 by scanner 220. For example, attack surface identification system 215 can provide interface descriptions 221 to scanner 220. An interface description describes how input is provided to an application. For example, an interface description can specify URIs at which the application accepts service requests, the operations performed in response to service requests (e.g., the HTTP methods implemented by application 214), parameter names and ranges for service requests, data types, and/or other information about the attack surface of application 214. Said differently, interface descriptions 221 are a description of the attack surface of application 214. Scanner 220 can then use interface descriptions 221 to assess security vulnerabilities of application 214. For example, scanner 220 can generate data sets for attacks to expose or identify security vulnerabilities of application 214.

Scanner 220 communicates with each of application 214 and attack surface identification system 215 via operating system 211, application server 212, framework 213, some combination thereof, or directly. Referring to the example illustrated in FIG. 2, scanner 220 communicates with application 214 and attack surface identification system 215 via operating system 211 and application server 212. That is, communication between scanner 220 and application 214 and attack surface identification system 215 is facilitated by operating system 211 and application server 212.

For example, application 214 can be a web application that is accessible via HTTP. Scanner 220 can communicate with application 214 using HTTP requests and responses. Additionally, scanner 220 can communicate with attack surface identification system 215 using particular, custom, or otherwise predetermined HTTP headers. Such headers will be generically referred to herein as “custom HTTP headers”. Said differently, scanner 220 can communicate with each of application 214 and attack surface identification system 215 using a common or single communications channel. A communications channel is a logical flow of data between computing devices, applications (e.g., web services or web applications), or a combination thereof. For example, the communications channel can be an HTTP communications channel (or HTTP session) between application 214 and scanner 220 (e.g., a sequence of related HTTP requests and responses exchanged by application 214 and scanner 220 via one or more Transmission Control Protocol over Internet Protocol (TCP/IP) streams).

In other words, in some implementations, scanner 220 embeds data for attack surface identification system 215 in a communications channel between application 214 and scanner 220. Operating system 211, application server 212, framework 213, and/or some other module then provides the embedded data to attack surface identification system 215. For example, application server 212 can extract the embedded data and provide that data to attack surface identification system 215. As another example, application server 212 can forward all data from the communications channel to attack surface identification system 215, and attack surface identification system 215 can extract the embedded data. As yet another example, attack surface identification system 215 can monitor operating system 211, application server 212, framework 213, and/or some other module and extract or copy the embedded data from the communications channel.

More specifically in reference to the example above, scanner 220 embeds data (e.g., a request for attack surface information) for attack surface identification system 215 in custom HTTP headers transmitted using the HTTP communications channel between application 214 and scanner 220, and application server 212 provides the custom HTTP headers to attack surface identification system 215. Other HTTP requests (and portions of HTTP requests other than custom HTTP headers) are provided by application server 212 to application 214. Moreover, application server 212 can provide data from attack surface identification system 215 within custom HTTP headers of the HTTP communications channel between application 214 and scanner 220. In other words, application server 212 can embed data from attack surface identification system 215 within custom HTTP headers and provide HTTP responses including those custom HTTP headers and other data from application 214 to scanner 220.

As used herein, “data within a custom HTTP header” and similar phrases means that the data itself is within a custom HTTP header and/or that a custom HTTP header includes a reference to the data or indication that the data is available at another location. As an example of the former, a data set can be included within a custom HTTP header. As an example of the latter, the custom HTTP headers can be used to provide an indication that another portion of an HTTP communications channel includes data for scanner 220 or attack surface identification system 215. For example, application server 212 can provide within a custom HTTP header of the HTTP communications channel between application 214 and scanner 220 an indication (e.g., a data value or group of data values such as a character string) that data from attack surface identification system 215 is included within a body portion of an HTTP communications channel (e.g., the body of an HTTP response). Thus, data that are embedded, included, or provided within a custom HTTP header can be fully within the custom HTTP header or identified in the custom HTTP header.

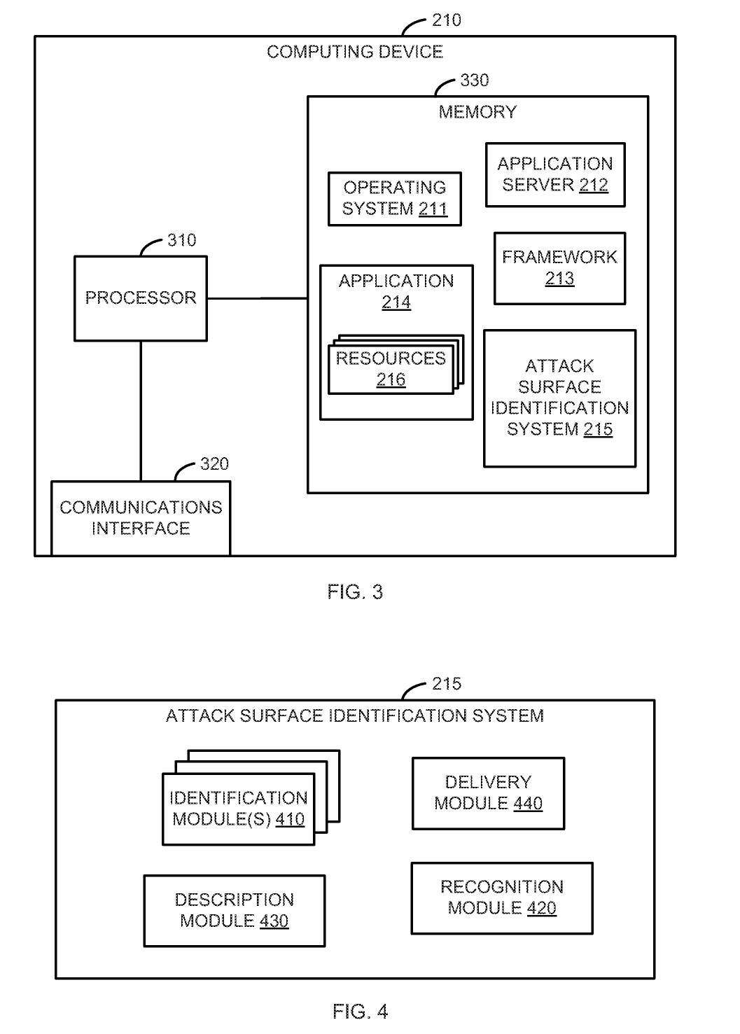

FIG. 3 is a schematic block diagram of the computing device of FIG. 2 hosting an attack surface identification system, according to an implementation. In the example illustrated in FIG. 3, computing device 210 includes processor 310, communications interface 320, and memory 330. Processor 310 is any combination of hardware and software that executes or interprets instructions, codes, or signals. For example, processor 310 can be a microprocessor, an application-specific integrated circuit (ASIC), a distributed processor such as a cluster or network of processors or computing devices, a multi-core or multi-processor processor, or a virtual or logical processor of a virtual machine.

Communications interface 320 is a module via which processor 310 can communicate with other processors or computing devices via communications link. For example, communications interface 320 can include a network interface card and a communications protocol stack hosted at processor 310 (e.g., instructions or code stored at memory 330 and executed or interpreted at processor 310 to implement a network protocol) to communicate with clients of application 214 or with a scanner. As specific examples, communications interface 320 can be a wired interface, a wireless interface, an Ethernet interface, a Fiber Channel interface, an InfiniBand interface, and IEEE 802.11 interface, or some other communications interface via which processor 310 can exchange signals or symbols representing data to communicate with other processors or computing devices.

Memory 330 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 330 can be a volatile random access memory (RAM), a persistent data store such as a hard disk drive or a solid-state drive, a compact disc (CD), a digital video disc (DVD), a Secure Digital™ (SD) card, a MultiMediaCard (MMC) card, a CompactFlash™ (CF) card, or a combination thereof or other memories. Said differently, memory 330 can represented multiple processor-readable media. In some implementations, memory 330 can be integrated with processor 310, separate from processor 310, or external to computing device 210.

Memory 330 includes instructions or codes that when executed at processor 310 implements operating system 211, application server 212, framework 213, application 214, and attack surface identification system 215. In the example illustrated in FIG. 3, application 214 includes resources 216. Resources 216 can include modules of application 214 that provide functionalities to application 214 when executed at processor 310 (e.g., Java™ class files, object files, or script files), media files (e.g., image or video files), database tables, or other resources. In some implementations, resources 216 are stored within a filesystem of memory 330.

In some implementations, computing device 210 can be a virtualized computing device. For example, computing device 210 can be hosted as a virtual machine at a computing server. Moreover, in some implementations, computing device 210 can be a virtualized computing appliance, and operating system 211 is a minimal or just-enough operating system to support (e.g., provide services such as a communications protocol stack and access to components of computing device 210 such as communications interface 320) application server 212, framework 213, application 214, and attack surface identification system 215.

Application server 212, framework 213, application 214, and attack surface identification system 215 can be accessed or installed at computing device 210 from a variety of memories or processor-readable media. For example, computing device 210 can access application server 212, framework 213, application 214, and attack surface identification system 215 at a remote processor-readable medium via communications interface 320. As a specific example, computing device 210 can be a thin client that accesses operating system 211 and application server 212, framework 213, application 214, and attack surface identification system 215 during a boot sequence.

As another example, computing device 210 can include (not illustrated in FIG. 3) a processor-readable medium access device (e.g., CD, DVD, SD, MMC, or a CF drive or reader), and can access application server 212, framework 213, application 214, and attack surface identification system 215 at a processor-readable medium via that processor-readable medium access device. As a more specific example, the processor-readable medium access device can be a DVD drive at which a DVD including an installation package for one or more of application server 212, framework 213, application 214, and attack surface identification system 215 is accessible. The installation package can be executed or interpreted at processor 310 to install one or more of application server 212, framework 213, application 214, and attack surface identification system 215 at computing device 210 (e.g., at memory 330). Computing device 210 can then host or execute the application server 212, framework 213, application 214, and/or attack surface identification system 215.

In some implementations, application server 212, framework 213, application 214, and attack surface identification system 215 can be accessed at or installed from multiple sources, locations, or resources. For example, some of application server 212, framework 213, application 214, and attack surface identification system 215 can be installed via a communications link, and others of application server 212, framework 213, application 214, and attack surface identification system 215 can be installed from a DVD.

In other implementations, application server 212, framework 213, application 214, and attack surface identification system 215 can be distributed across multiple computing devices. That is, some components of application server 212, framework 213, application 214, and attack surface identification system 215 can be hosted at one computing device and other components of application server 212, framework 213, application 214, and attack surface identification system 215 can be hosted at another computing device. As a specific example, application server 212, framework 213, application 214, and attack surface identification system 215 can be hosted within a cluster of computing devices where each of application server 212, framework 213, application 214, and attack surface identification system 215 is hosted at multiple computing devices, and no single computing device hosts each of application server 212, framework 213, application 214, and attack surface identification system 215.

FIG. 4 is a schematic block diagram of an attack surface identification system, according to an implementation. As discussed above, attack surface identification system 215 can interact with an application by instrumenting the application with monitor code. Identification module 410 include one or more identification modules that identify information related to the attack surface of an application. For example, one identification module can include logic to identify RESTful interface mappings based on annotations that describe how RESTful requests are handled by the application (e.g., to which modules or resources of the application RESTful requests and related parameters or arguments are provided). Such an identification module can identify the annotations using various methodologies such as reflection (e.g., class, object, or type introspection) at the application and parsing or analyzing metadata associated with the application. Reflection is a methodology available in some programming languages and/or runtime environments that allows an application or another application to observe and/or modify the structure and logic of the application at runtime. As a specific example, such an identification module can identify JAX-RS annotations.

As another example, an identification module can interact with (e.g., via an API or monitor code) an application server hosting an application to identify a context path of the application. A context path is logical path at which the application is accessible via the application server. For example, the application server can host multiple applications and provide a unique context path for each application. As a specific example, an application server accessible at the URI www.example.com can host a first application and a second application. The first application can have a context path of www.example.com/app1, and the second application can have a context path of www.example.com/app2. In these examples, the context paths are absolute. Other context paths can be relative. That is, the context path for the first application can be /app1, and the context path for the second application can be /app2. These context paths are relative to the application server path or URI of www.example.com. Thus, the first application is accessible at the URI www.example.com/app1, and the second application is accessible at the URI www.example.com/app2.

Moreover, as another example, an identification module can intercept, for example, via monitor code, execution of the application and receive information related to a filesystem path of the application. The identification module can then identify resources of the application using a variety of methodologies. For example, the identification module can then traverse the filesystem path of the application to identify resources of the application. In other words, the identification module can receive information related to the location of the application within a filesystem of a computing system hosting the application when execution of the application is intercepted by attack surface identification system 215 (or monitor code installed by attack surface identification system 215). The identification module can then search for resources (e.g., Java™ class files, object files, script files, or other executable resources) within sub- and super-directories of the filesystem path of the application.

As an alternative example, the identification module can query a framework, an application server, or a runtime environment of the application to identify resources of the application. For example, a framework, an application server, or a runtime environment of the application can provide an API that is accessible to the identification module, and at which the identification module can access information regarding the resources of the application.

In some implementations, the structure of an application is dependent on the framework (or frameworks) of or used by the application. For example, the location of resources of the application or annotations can depend on the framework of the application. Recognition module 420 includes logic to identify a framework of the application. Often, frameworks include characteristics that distinguish or uniquely identify one framework from another. For example, frameworks can include particular classes, resources, APIs, resources at particular locations within a filesystem, and/or other characteristics that identify those frameworks. Recognition module 420 can use monitor code, access APIs, traverse filesystem paths, and/or use other methodologies to identify such characteristics and recognize a framework of an application.

Furthermore, because the structure of an application can depend on the framework (or frameworks) of or used by the application, identification modules 410 can include identification modules that are specific to particular frameworks. Thus, as an example, identification modules 410 can include separate identification modules to identify an attack surface of an application with a Jersey™ framework, an attack surface of an application with an Apache Wink™ framework, and an attack surface of an application with a Microsoft ASP .NET MVC™ framework. Accordingly, attack surface identification system 215 can identify attack surfaces of applications using a variety of frameworks.

Description module 430 includes logic to define an interface description based on the information about the attack surface of the application identified by identification module 410. Description module 430 can, for example, combine a context path of an application with information (e.g., file names) of resources of an application identified in a traversal of the filesystem path of the application to define URIs via which those resources are accessible. As another example, description module 430 can describe parameter names and ranges for a query string and a URI via which that query string can be provided to the application.

Delivery module 440 provides interface descriptions to a scanner. As discussed above, in some implementations, delivery module 440 can embed or include the interface descriptions in custom HTTP headers and provide those custom HTTP headers to the scanner via an HTTP communications channel between the application and the scanner.

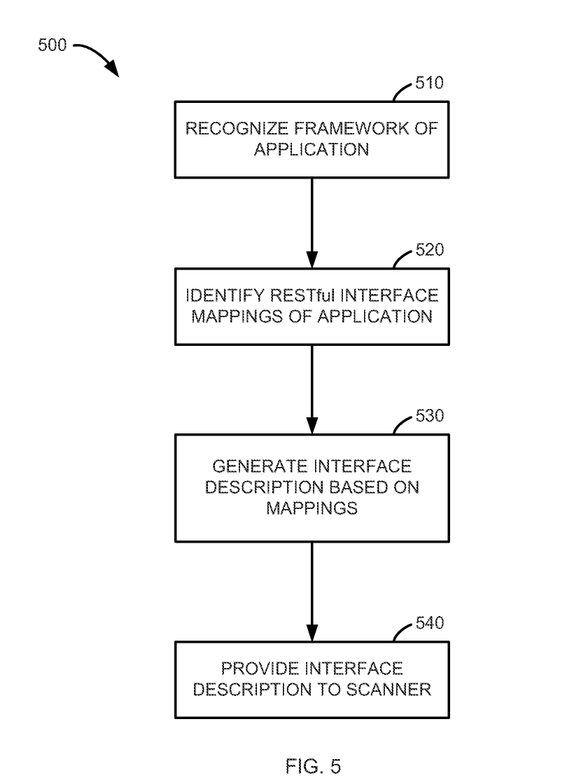

FIG. 5 is a flowchart of an attack surface identification process, according to another implementation. Process 500 can be implemented at an attack surface identification system. A framework of an application is recognized at block 510. For example, the framework of the application can be identified based on characteristics such as classes, resources, locations of classes and resources, APIs, or other characteristics.

RESTful interface mappings of the application are then identified at block 520. RESTful interface mappings can be identified using, for example, reflection at the application. Accordingly, the RESTful interface mappings can be identified based on a bytecode representation of the application while the application is hosted at an application server. As a specific example, the application can be a Java™ application compiled to bytecode (or in a bytecode representation) and hosted at an application server, and the attack surface identification system implementing process 500 can identify RESTful interface mappings using reflection with the objects of the application.

As another specific example, the application can be a Microsoft ASP .NET MVC™ application compiled to bytecode and hosted at an application server, and the attack surface identification system implementing process 500 can identify RESTful interface mappings by hooking or instrumenting classes within the System.Web.Routing namespace. As another example, RESTful interface mappings can be identified based on metadata associated with the application. For example, the RESTful interface mappings can be described in a manifest file of the application, and the attack surface identification system implementing process 500 can analyze the manifest file to identify RESTful interface mappings of the application.

After the RESTful interface mappings of the application are identified at block 520, interface descriptions are generated based on the mappings at block 530. For example, interface descriptions specifying URIs at which the application accepts input such as service requests, and the parameter names, ranges, and data types accepted as input can be generated at block 530. In some implementations, the interface descriptions can be structured documents such as Extensible Markup Language (XML) documents. More specifically, for example, an interface description can be a Web Application Description Language (WADL) document or Web Services Definition Language (WSDL) document.

The interface descriptions are then provided to a scanner at block 540. The scanner can use the interface descriptions to formulate or structure attacks (e.g., service requests with particular parameter names, values, and/or data types that are directed to specific URIs) to expose or identify security vulnerabilities. Additionally, process 500 illustrated in FIG. 5 is an example implementation of a process to identify an attack surface of an application. In other implementations, such a process can include more or fewer blocks and/or rearranged blocks

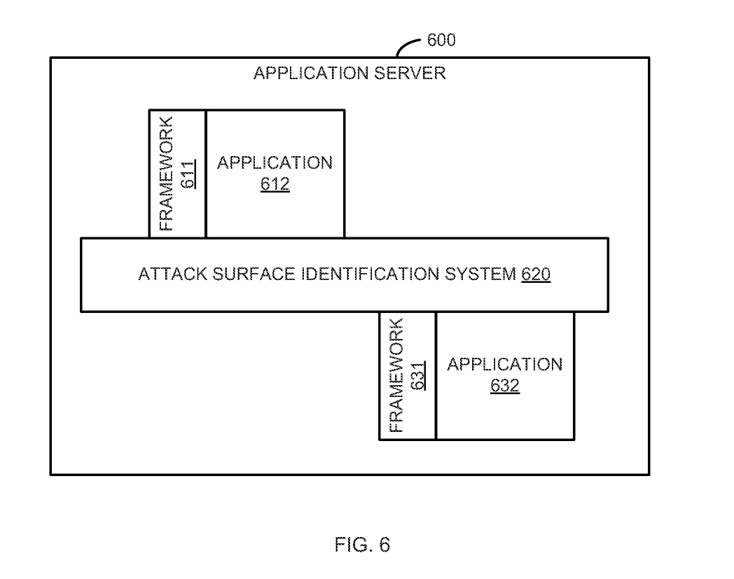

In some implementations, an attack surface identification system 620 identifies an attack surface of multiple applications hosted at an application server 600. For example, FIG. 6 is an illustration of an attack surface identification system in communication with an application server and applications hosted at the application server, according to an implementation. Application 612 uses framework 611 and is hosted at application server 600. Similarly, application 632 uses framework 631 and is hosted at application server 600. Attack surface identification system 620 identifies an attack surface of application 612 and an attack surface of application 632.

For example, attack surface identification system 620 can implement process 500 and/or process 700 discussed below for application 612 and process 500 for application 632. That is, attack surface identification system 620 can execute the blocks of process 500 relative to framework 611 and application 612 in one iteration, and can then execute the blocks of process 500 relative to framework 631 and application 632 in another iteration. In other implementations, identification system 620 can execute the blocks of process 500 relative to framework 611 and application 612 and relative to framework 631 and application 632 in parallel.

Moreover, because attack surface identification system 620 can communicate with a scanner using or via a communications channel between a scanner and an application, attack surface identification system 620 can provide an interface description for application 612 to one scanner and an interface description for application 632 to another scanner. In other words, attack surface identification system 620 can provide an interface description for application 612 to a first scanner via a communications channel between the first scanner and application 612, and an interface description for application 632 to a second scanner via a communications channel between the second scanner and application 632.

In other implementations, multiple of instances of an attack surface identification system can be hosted at a computing device with an application server hosting multiple applications. In such implementations, each instance of the attack surface identification system identifies an attack surface of one application. That is, for example, each instance of attack surface identification system performs process 500 and/or process 700 discussed below relative to one application.

In yet other implementations, multiple instances of an application server can be hosted at a computing device (or group of computing devices) at which an attack surface identification system is also hosted. Each instance of the application server can host an application using a framework. That is, an instance of the application server exists for each application. The attack surface identification system can identify an attack surface for the application at each instance of the application server. For example, the attack surface identification system can implement process 500 and/or process 700 discussed below the application at each instance of the application server.

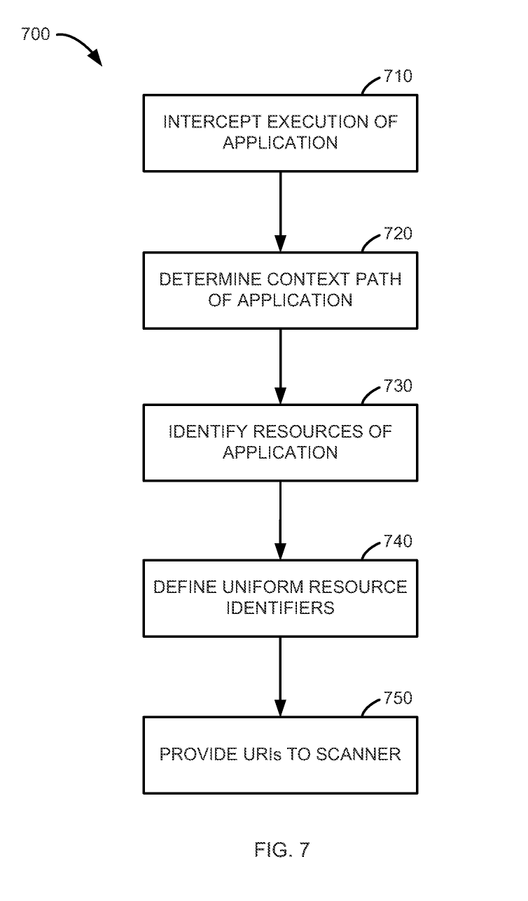

FIG. 7 is a flowchart of an attack surface identification process, according to another implementation. Similar to process 500, process 700 can be implemented at an attack surface identification system to identify an attack surface of an application. Execution of the application is intercepted at block 710. For example, an attack surface identification system can instrument an application or an application server or operating system hosting the application with monitor code as discussed above. The attack surface identification system can then intercept the application (or execution of the application) when that monitor code is executed at a processor.

In some implementations, the attack surface identification system can also identify the application. For example, the attack surface identification system can receive or access data that identifies the application when the application is intercepted. For example, environment variables or parameters that are available the attack surface identification system after execution of monitor code at a processor can provide identification information (e.g., a file name, a class name, or a path) of the application.

A context path of the application is then determined at block 720. As discussed above, the context path describes at what location (e.g., relative to the application server hosting the application) the application is accessible. The context path of the application can be accessed from the application server hosting the application using, for example, an API of the application server, monitor code installed at the application, or using other methodologies.

Similarly, resources of the application are identified at block 730. For example, an attack surface identification system implementing process 700 can traverse a filesystem path of the application to identify resources (e.g., class files, object files, script files, or other resources) associated with the application. That is, for example, the attack surface identification system can examine directories of the filesystem of a computing device hosting the application that are sub- or super-directories of a directory identified by the filesystem path of the application to identify resources of the application. The attack surface identification system can determine the filesystem path of the application using, for example, an API of the application server, monitor code installed at the application, identification information of the application, and/or other information or methodologies.

Uniform resource identifiers (URIs) are then defined at block 740 based on the context path and resources of the application. These URIs represent interfaces of the application. For example, these URIs can identify input interface of the application. Said differently, these URIs are interface descriptors of the application. The URIs can be defined by combining the context path and filesystem paths (or elements or portions thereof) of resources of the application identified at block 730. For example, the URIs can be defined by using the context path of the application as a base of the URIs, and appending the filesystem paths of the resources relative to the filesystem path of the application to the base.

As a specific example, an application can have a context path www.example.com/app, a filesystem path/web-applications/app, and resources at filesystem paths/web-applications/app/resources/resource1 and /web-applications/app/resources/resource2. The URIs defined at block 740 can be www.example.com/app/resources/resource1 and www.example.com/app/resources/resource2. In other implementations, the context path of the application, filesystem path of the application, and filesystem paths of resources of the application can be combined using other methodologies to define URIs that describe interfaces or the attack surface of the application.

The URIs defined at block 740 are provided to a scanner at block 750, and the scanner can use the URIs to formulate and execute security vulnerability tests or analyses of the application. Additionally, process 700 illustrated in FIG. 7 is an example implementation of a process to identify an attack surface of an application. In other implementations, such a process can include more or fewer blocks and/or rearranged blocks. As an example, blocks 720 and 730 can be rearranged or performed in parallel.

While certain implementations have been shown and described above, various changes in form and details may be made. For example, some features that have been described in relation to one implementation and/or process can be related to other implementations. As a specific example, portions of the methodology illustrated and discussed in relation to FIG. 5 can be applicable to the methodology illustrated and discussed in relation to FIG. 7. In other words, processes, features, components, and/or properties described in relation to one implementation can be useful in other implementations. As another specific example, implementations discussed in relation to RESTful interface mappings can be applicable to other interface mappings. As another example, functionalities discussed above in relation to specific modules or elements can be included at different modules, engines, or elements in other implementations.

Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or at hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanism (e.g., sending an interface description to a scanner via a communications path or channel), pull mechanisms (e.g., delivering an interface description to a scanner in response to a request from the scanner), and store mechanisms (e.g., storing an interface description at a data store or service at which a scanner can access the interface description). Furthermore, as used herein, the term “based on” means “based at least in part on.” Thus, a feature that is described as based on some cause, can be based only on the cause, or based on that cause and on one or more other causes.

What is claimed is:

1. A processor-readable medium storing code representing instructions that when executed at a processor cause the processor to:
identify an interface mapping of an application hosted at an application server;
generate an interface description of the application based on the interface mapping; and
provide the interface description to a scanner.

2. The processor-readable medium of claim 1, wherein the interface mapping is a RESTful interface mapping identified based on reflection at the application.

3. The processor-readable medium of claim 1, wherein the interface mapping is a RESTful interface mapping identified based on metadata associated with the application.

4. The processor-readable medium of claim 1, wherein the interface mapping is a RESTful interface mapping identified during runtime of the application.

5. The processor-readable medium of claim 1, wherein the interface description is provided to the scanner via a communications channel between the application and the scanner.

6. The processor-readable medium of claim 1, wherein the application is in a bytecode representation.

7. The processor-readable medium of claim 1, wherein the interface mapping is a Java API for RESTful Web Services annotation.

8. The processor-readable medium of claim 1, further comprising code representing instructions that when executed at a processor cause the processor
receive a request for the interface description within a Hypertext Transfer Protocol request header provided to the application by the scanner.

9. The processor-readable medium of claim 1, further comprising code representing instructions that when executed at a processor cause the processor to:
recognize a framework of the application, identifying the interface mapping of the application based on the framework of the application.

10. The processor-readable medium of claim 1, further comprising code representing instructions that when executed at a processor cause the processor to:
identify at runtime of the application a context path of the application and a plurality of resources of the application, each resource from the plurality of resources having a filesystem path; and
define a plurality of uniform resource identifiers, each uniform resource identifier based on the context path of the application and the filesystem path of a resource from the plurality of resources.

11. A processor-readable medium storing code representing instructions that when executed at a processor cause the processor to:
determine a context path of the application;
identify a plurality of resources of the application, each resource from the plurality of resources having a filesystem path;
define an interface description for the application including a plurality of uniform resource identifiers, each uniform resource identifier based on the context path and the filesystem path of a resource from the plurality of resources; and
provide the interface description to a scanner via a communications channel between the scanner and the application.

12. The processor-readable medium of claim 11, further comprising code representing instructions that when executed at a processor cause the processor to:
intercept execution of an application, the context path of the application is determined in response to intercepting execution of the application.

13. The processor-readable medium of claim 11, further comprising code representing instructions that when executed at a processor cause the processor to:
receive a request for the interface description within a Hypertext Transfer Protocol request header provided to the application by a scanner in communication with the application,
the interlace description is provided to the scanner in response to the request.

14. The processor-readable medium of claim 11, wherein:
the context path of the application is determined at runtime; and
the plurality of resources of the application are identified by traversing a filesystem path of the application at runtime of the application.

15. The processor-readable medium of claim 11, further comprising code representing instructions that when executed at a processor cause the processor to:
identify RESTful interface mappings of the application,
the interface description for the application is based on the RESTful interface mappings.

16. An attack surface identification system, comprising:
a recognition module to identify a first framework of a first application hosted at an application server and a second framework of a second application hosted at the application server, the second framework different from the first framework;
a first identification module to identify RESTful interfaces at the first application;
a second identification module to identify RESTful interfaces at the second application; and
a description module to define a first interface description for the first application and a second interface description for the second interface description.

17. The system of claim 16, further comprising:
a delivery module to provide the first interface description to a first scanner in communication with the first application and the second interface description to a second scanner in communication with the second application.

18. The system of claim 16, wherein:
the first identification module identifies the RESTful interfaces at the first application based on RESTful interface mappings of the first application; and
the second identification module identifies the RESTful interfaces at the second application based on RESTful interface mappings of the second application.

19. The system of claim 16, wherein:
the first identification module identifies the RESTful interfaces at the first application during execution of the first application and based on RESTful interface mappings of the first application; and
the second identification module identifies the RESTful interfaces at the second application during execution of the first application and based on RESTful interface mappings of the second application.

20. The system of claim 16, further comprising:
a path module to determine a context path of the first application and a plurality of resources of the first application, each resource from the plurality of resources having a filesystem path,
the description module operable to define a plurality of uniform resource identifiers for the first application, each uniform resource identifier based on the context path and the filesystem path of a resource from the plurality of resources.
